(19) United States
(12) Patent Application Publication
(10) Pub. No.: US 2003/0006314 A1
(43) Pub. Date: Jan. 9, 2003

(54) Faucet structure

(76) Inventor: Yu-Chao Chao, Lu-Kang Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/900,179

(22) Filed: Jul. 9, 2001

(51) Int. Cl. B05B 1/26

(52) U.S. Cl. 239/523

(57) ABSTRACT

A faucet structure mainly comprises an outer pipe, an inner seat and a rotatable portion. The inner seat has a central ring portion and several fixing ribs. The rotatable portion has a screw portion and a sealing portion. So, the outer surface of the sealing portion can be rotated in to close the water outlet. Or, it can be rotated out by a user's fingers to form a ring-shaped gap for allowing water flow out. In summary, in this invention, the washing area is larger. There is no need to wash the faucet after the hands are washed. It significantly improves the public sanitary level. The application scope is wide. The manufacture cost is low. It has various designs. The leaking problem caused by sands can be solved. The out flowing water is more evenly. And, it can save more water.

### BACKGROUND OF INVENTION

1. Field of the Invention

This invention relates to a faucet structure, especially to a unique faucet structure having the advantages or functions as follows: the ring-shaped washing area is larger, there is no need to wash the faucet after the hands are washed, it significantly improves the public sanitary level, the application scope is wide, the manufacture cost is low, it has various designs, the leaking problem caused by sands can be avoided, the flow-out water is more evenly, and it can save more water.

2. Description of the Prior Art

As shown in FIG. 1, the traditional faucet 90 comprises a downward water outlet 91 and an upward extended rotatable knob 92. Usually, the flow-out diameter D1 of the traditional faucet is smaller than 2 cm. So, the traditional flow-out area is approximately 3.14 cm². When a person wants to wash his hands, unless the hands are placed horizontally (facing up or down), this person must move his hands to the left and to the right repeatedly. Otherwise, this person's hands have to be placed vertically. Thus, because the washing area is small, the washing efficient is low.

The worst condition is described below. When a user's hands are stuck with some oil, mud or other dirty stuff, the whole washing procedure can be divided into the following three steps.

The first step is to rotate the rotatable knob 92. At the same time, the rotatable knob 92 becomes dirty.

The second step is to wash the hands. After the hands are washed, the hands are clean. But, when the user contact the rotatable knob 92 to close it (also will contact the oil, mud, and dirty stuff on the rotatable knob 92), the clean hands become dirty again. Thus, there is no washing efficiency at all.

Some smarter persons might use both hands to hold some water up to clean the rotatable knob 92 during the washing procedure. This action is defined as the third step. However, in case the outer surface of the rotatable knob 92 is irregular (or has recesses), some oil, mud or dirty stuff still sticks on the recessed portions (hard to be cleaned).

Please note that the third step is quite complicated for a kid. In case there are some germs or bacteria staying on the rotatable knob 92. These germs or bacteria will transmit to the next user or users. It will cause a serious public sanitary problem.

The more terrible condition is that the traditional faucet is located in a public toilet (no matter a bus station, park, restaurant, department store, etc.), especially the male toilet, the germs or bacteria might be transmitted via the male user's urine through the fingers to the faucet's rotatable knob 92. If the previous faucet user is a disease carrier (like venereal disease, syphilis, AIDS, etc.), it is hard to image the result of the next faucet user or users.

In addition, the traditional faucet is manufactured by casting method. The design is limited to the casting procedure. The change for the faucet design is limited.

Also, the traditional research and development are only focused on the hot and cold water mixing, flow rate control, etc. It totally ignores the serious problem behind the above-mention washing steps. Therefore, it is necessary to invent a new product to solve the above-mentioned problem.

### SUMMARY OF THE INVENTION

The primary object of this invention is to provide a faucet structure. In which, it has the following advantages or functions: the washing area is larger, there is no need to wash the faucet after the hands are washed, it significantly improves the public sanitary level, the application scope is wide, the manufacture cost is low, and it has various designs.

The second object of this invention is to provide a faucet structure. In which, the leaking problem caused by sands can be avoided, the flow-out water is more evenly, and it can save more water.

### BRIEF DESCRIPTION OF THE DRAWINGS

FIG. 1 shows a traditional faucet.

FIG. 2 is a side view of this invention in a close condition.

FIG. 3 is a side view of this invention in an open condition.

FIG. 4 is a cross-sectional view of this invention.

FIG. 5 is an exploded view of this invention.

FIG. 6 is an exploded view of the second embodiment of this invention.

FIG. 7 illustrates the third embodiment of this invention.

FIG. 8 shows the fourth embodiment of this invention.

FIG. 9 is an exploded view of the fifth embodiment of the invention.

FIG. 10 is perspective view of the modified outer pipe and inner seat.

FIG. 11 is a cross-sectional view of the fifth embodiment in a close condition.

FIG. 12 is a cross-sectional view of the fifth embodiment in an open condition.

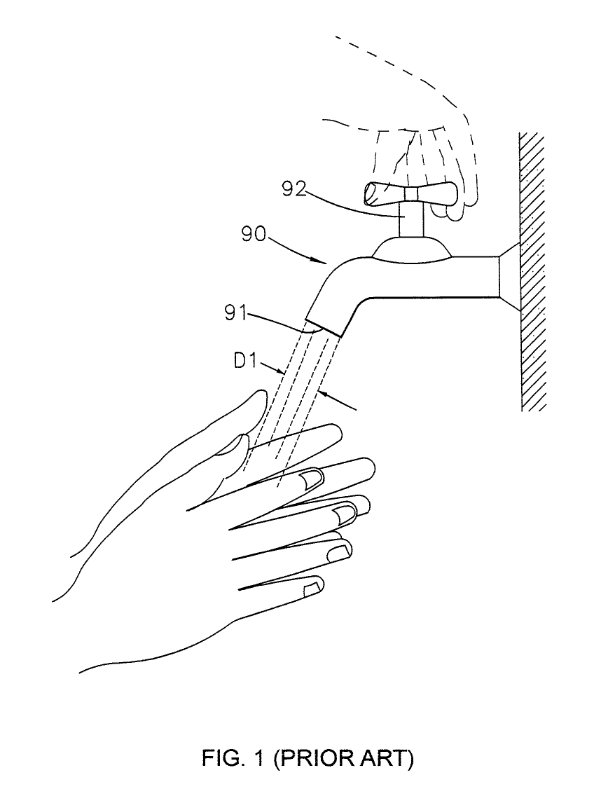

### DETAILED DESCRIPTION OF THE PREFERRED EMBODIMENT

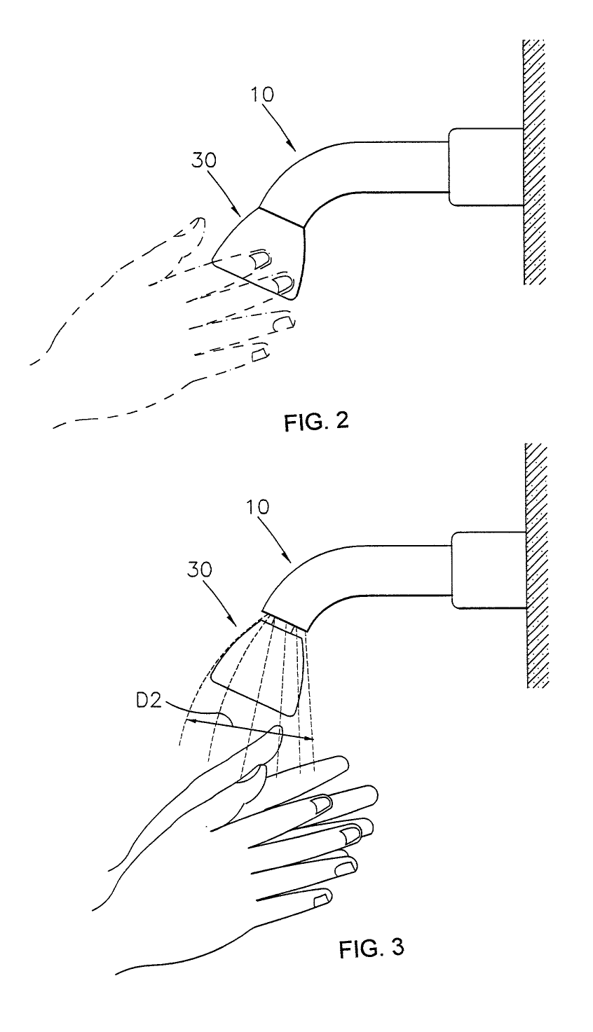

Referring to FIGS. 2 to 5, this invention relates to a faucet structure. In the first embodiment, this invention mainly comprises an outer pipe 10, an inner seat 20 and a rotatable portion 30.

The outer pipe 10 has an inner wall 11 with a predetermined diameter (such as 2 cm). The outer pipe 10 has a water outlet 12. In which, there is a substantially ring-shaped water stopping sloped area 13. This water stopping sloped area 13 is a sloped surface or a curved surface.

The inner seat 20 has a central ring portion 21 and a plurality of fixing ribs 22 radially extending from the central ring portion 21 so as to secure on the inner wall 11 of the outer pipe 10 (secured by adhesive, pressing, or welding method). A central thread hole 211 is disposed on the central ring portion 21. Several spaces are provided between every two adjacent fixing ribs 22 to allow water or fluid flowing through.

The rotatable portion 30 has a screw portion 31 and a sealing portion 32. The screw portion 31 is fitted with the central thread hole 211. And, an outer surface of the sealing portion 32 is a predetermined curved or sloped surface (matching with the water stopping sloped area 13).

So, the outer surface of the sealing portion 32 can be rotated in to contact with the water stopping sloped area 13 of the outer pipe 10 so as to close the water outlet 12. Or, it can be rotated out by a user's fingers so as to form a ring-shaped gap for allowing water flow out.

More specifically, the sealing portion 32 is a substantially curved cone with a maximum outer diameter between 2 cm to 10 cm (the optimum value is between 3 to 5 cm) so that the user's fingers are easy to control.

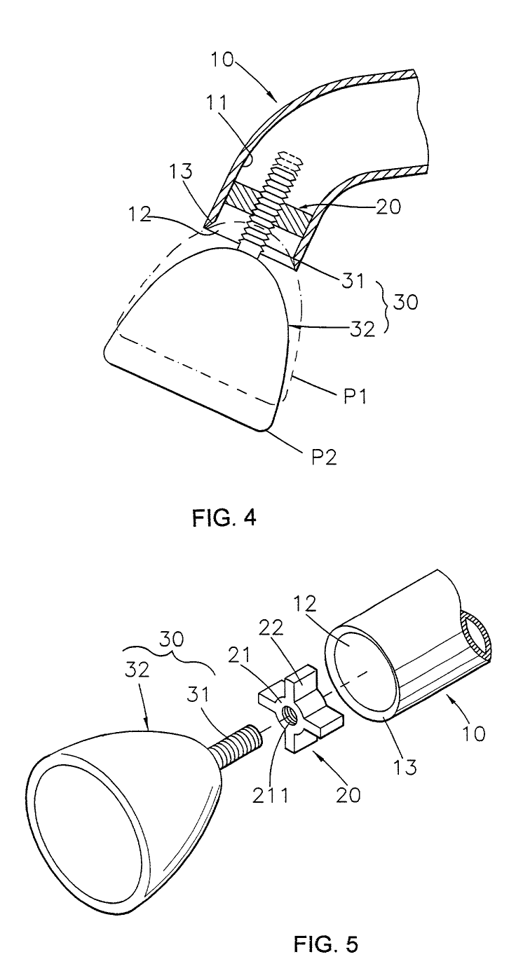

In operation, as shown in FIG. 4, that the rotatable portion 30 is complete rotated in. It is the “close” condition that is defined as a first position P1. Under this condition, no water flows out.

When the user's fingers slowly rotate the rotatable portion 30 out, as shown in FIG. 4, the outer surface of the sealing portion 32 is gradually separated from the water stopping sloped area 13. It is the “open” condition that is defined as a second position P2. Thus, a ring-shaped water gradually flows out. Please see FIG. 3, this flowing water is ring-shaped. The water flow-out diameter D2 is approximately 5 to 10 cm. Assuming that the ring-shaped area is between the inner diameter of 7 cm and the outer diameter of 8 cm, the ring-shaped area will be approximately 12 cm². It is very suitable for a user to wash a person's hands. No matter one's hands are placed vertically or horizontally, the washing area is large enough. Thus, the ring-shaped water flow-out area (approx. 12 cm²) is much larger than the area (approx. 3.14 cm²) of the traditional faucet. The ring-shaped washing area of this invention is larger. So, the washing efficiency of this invention is high.

Furthermore, when the user's hands are stuck with some oil, mud or other dirty stuff, the hands need to contact with and rotate the outer surface of the sealing portion 32 of the rotatable portion 30 in order to open the faucet. After the water flows out, the clean water will pass through the sealing portion 32 and then flush away the oil, mud and other dirty stuff on the sealing portion 32. After washing the user's hands, the hands become clean. The user can rotate it back to its original state. Of course, the rotatable portion 30 is still kept clean. There is no need to wash the faucet again. It significantly improves the public sanitary level.

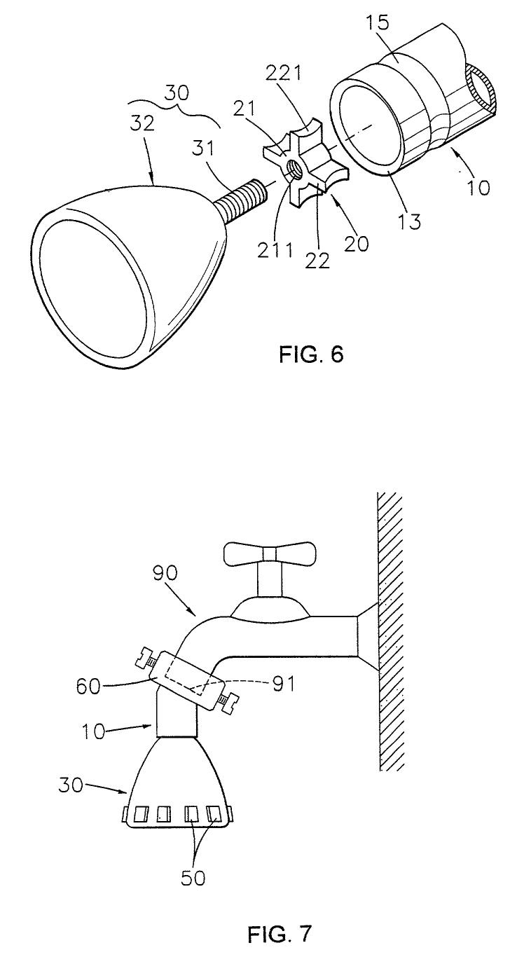

FIG. 6 shows the second embodiment of this invention. In which, the outer pipe 10 has a rolling recess 15 manufactured by a rolling/pressing machine (not shown). Each of an outer edge of the fixing ribs 22 is disposed with a recessed portion 221 corresponding to the rolling recess 15. In actual manufacture, the inner seat 20 is pushed into the outer pipe 10. Then, by using a rolling/pressing machine, it will form the rolling recess 15. Finally, the inner seat 20 is firmly secured in the outer pipe 10 by an easy and cheap manufacturing step (without welding).

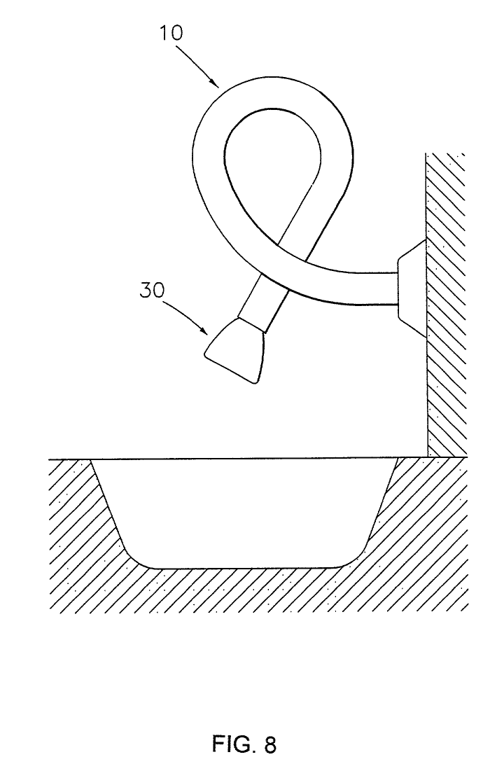

FIG. 7 illustrates the third embodiment of this invention. In which, a slip-proof portion 50 is disposed on the outer surface of the sealing portion 32. It may be a rough surface, embossed surface, protrusions, blocks etc. Therefore, the user is easier to apply the force on the rotatable portion 30 to rotate it in or out. Besides, it has an additional function of changing the flowing patterns.

In addition, the outer pipe 10 can further include a connecting inlet 60 so as to secure this invention on an outlet 91 of another traditional faucet 90. That is, this invention can be connected to traditional faucet 90 by four screws. So, the application scope of this invention is wide.

Moreover, due to the simple structure of this invention, this invention can be made by simply bending a straight tube to form an outer pipe 10 and inserting in an inner seat 20 with a rotatable portion 30. Thus, the manufacturing process is simple and its cost is low.

As shown in FIG. 8, the fourth embodiment of this invention has a special designed outer pipe 10. It can be simply bent to any possible shape or style for special design as desired. Therefore, it has the function of having various designs.

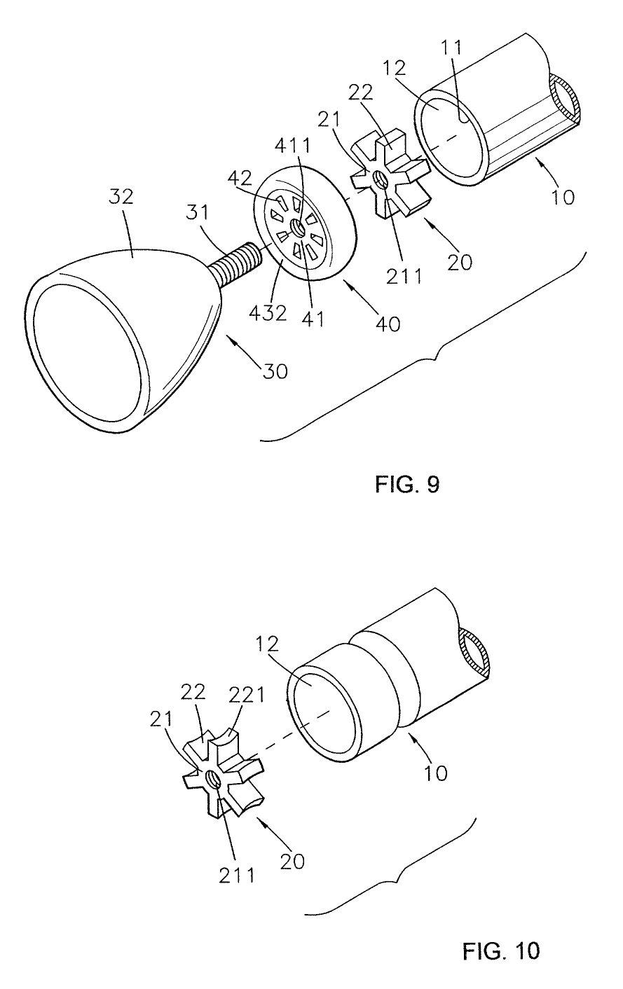

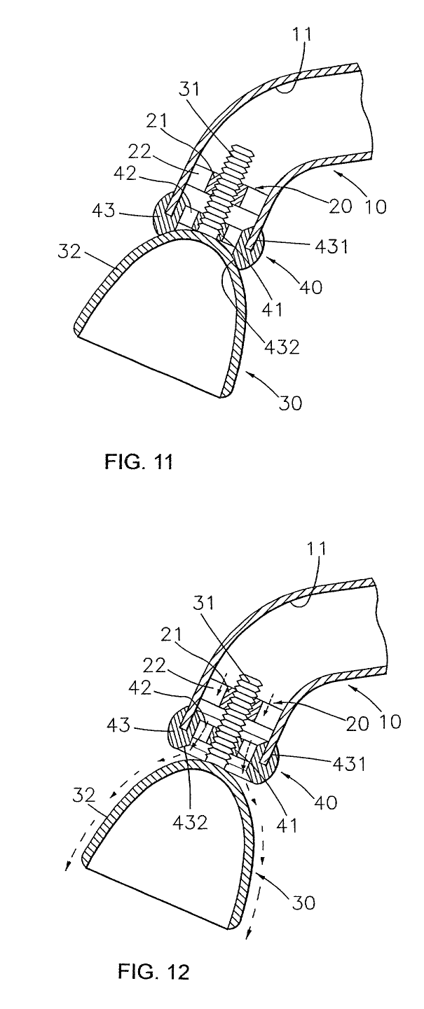

Referring to FIGS. 9 to 12, they show the fifth embodiment of this invention. Except the above-mentioned outer pipe 10, inner seat 20, and the rotatable portion 30, it further comprises an end fitting portion 40.

The end fitting portion 40 has a central shaft portion 41, several water guiding openings 42 and an outer ring portion 43. The central shaft portion 41 contains a guiding hole 411 for allowing the screw portion 31 passing through. The outer ring portion 43 has an engaging recess 431 for engaging with the outer pipe 10 and has a substantially ring-shaped water stopping sloped area 431 (replacing the original water stopping sloped area 13).

Of course, the edge of each fixing rib 22 can be modified as a recessed portion 221 shown in FIG. 10.

The other structure similar to the previous embodiment is not repeated to be described again. In this fifth embodiment, the end fitting portion 40 can be made by a plastic material. Thus, the sealing effect will be excellent between the plastic water stopping sloped area 431 and the metal sealing portion 32. Even though there are some tiny sands (or the like) in the water or stayed between the water stopping area 431 and the sealing portion 32, the plastic end fitting portion 40 still can firmly close the water outlet 12. Thus, the leaking problem caused by sands can be solved.

In addition, due to these guiding openings 42, the water will flow out more evenly and well distributed. Also, it will save more water.

The above embodiments are only used to illustrate the present invention, not intended to limit the scope thereof. Many modifications of the above embodiments can be made without departing from the spirit of the present invention.

What is claimed is:

1. A faucet structure comprising:
an outer pipe having an inner wall with a predetermined diameter, said outer pipe having a water outlet;
an inner seat having a central ring portion and a plurality of fixing ribs radially extending from said central ring portion so as to secure on said inner wall of said outer pipe, a central thread hole being disposed on said central ring portion, several spaces being provided between every two adjacent fixing ribs to allow water or fluid flowing through; and
a rotatable portion having a screw portion and a sealing portion, said screw portion being fitted with said central thread hole, and an outer surface of said sealing portion being a predetermined curved or sloped surface;
so that said outer surface of said sealing portion can be rotated in so as to close said water outlet, or can be rotated out by a user's fingers so as to form a ring-shaped gap for allowing water flow out.

2. The faucet structure as claimed in claim 1, further comprising:
an end fitting portion having a central shaft portion, several water guiding openings and an outer ring portion, said central shaft portion containing a guiding hole for allowing said screw portion passing through, said outer ring portion having an engaging recess for engaging with said outer pipe and having a substantially ring-shaped water stopping sloped area.

3. The faucet structure as claimed in claim 1, wherein
said sealing portion is a substantially curved cone with a maximum outer diameter between 2 cm to 10 cm so that the user's fingers are easy to control.

4. The faucet structure as claimed in claim 3, wherein a slip-proof portion is disposed on said outer surface of said sealing portion.

5. The faucet structure as claimed in claim 1 wherein said outer pipe has a rolling recess, and each of an outer edge of said fixing ribs is disposed with a recessed portion corresponding to said rolling recess.

6. The faucet structure as claimed in claim 1, wherein said outer pipe further includes a connecting inlet so as to secure on an outlet of another traditional faucet.

7. The faucet structure as claimed in claim 2, wherein said outer pipe further includes a connecting inlet so as to secure on an outlet of another traditional faucet.
